(19) United States
(12) Patent Application Publication
(10) Pub. No.: US 2026/0313687 A1
(43) Pub. Date: Oct. 8, 2026

(54) SHARED CHANNEL COLLISION RESOLUTION AND HYBRID AUTOMATED REPEAT REQUEST FOR SEMI PERSISTENT SCHEDULING IN SUB-BAND FULL DUPLEX

(71) Applicant: QUALCOMM Incorporated, San Diego, CA (US)

(72) Inventors: Mohammed JABI, San Diego, CA (US); Muhammad Sayed Khairy ABDELGHAFFAR, San Jose, CA (US); Abdelrahman Mohamed IBRAHIM, San Diego, CA (US)

(21) Appl. No.: 19/415,586

(22) Filed: Dec. 10, 2025

Related U.S. Application Data
(60) Provisional application No. 63/783,064, filed on Apr. 3, 2025.

(51) Int. Cl. H04W 74/0816; H04W 72/12

(52) U.S. Cl. CPC H04W 74/0816; H04W 72/12

(57) ABSTRACT

This disclosure provides methods, components, devices and systems for shared channel collision resolution and hybrid automated repeat request (HARQ) for semi persistent scheduling (SPS) in sub-band full duplex (SBFD). A user equipment (UE) may receive information that configures the UE for communications via SBFD symbols and via non-SBFD symbols in accordance with a first configuration for SBFD communications or a second configuration for SBFD communications, and information that configures a first set of SPS physical downlink shared channel (SPS-PDSCH) messages and a second set of SPS-PDSCH messages, where a collision resolution procedure is triggered based on a message of the second set of SPS-PDSCH messages at least partially overlapping with a message of the first set of SPS-PDSCH messages. The UE may select one or more instances of the first set of SPS-PDSCH messages for reception or feedback generation in accordance with the collision resolution procedure and exclusion rules.

### CROSS REFERENCE

The present Application for Patent claims the benefit of U.S. Provisional Patent Application No. 63/783,064 by JABI et al., entitled “SHARED CHANNEL COLLISION RESOLUTION AND HYBRID AUTOMATED REPEAT REQUEST FOR SEMI PERSISTENT SCHEDULING IN SUB-BAND FULL DUPLEX” filed Apr. 3, 2025, which is assigned to the assignee hereof, and expressly incorporated by reference in its entirety herein.

### TECHNICAL FIELD

This disclosure relates generally to wireless communication, and more specifically to systems, devices, methods, and techniques associated with shared channel collision resolution and hybrid automated repeat request for semi persistent scheduling in sub-band full duplex.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving first information that configures the UE for communications via sub-band full duplex (SBFD) symbols and via non-SBFD symbols in accordance with a first configuration for SBFD communications or a second configuration for SBFD communications, where the first configuration for SBFD communications defines valid symbols for the SBFD communications as corresponding to one of the SBFD symbols or the non-SBFD symbols, and where the second configuration for SBFD communications defines valid symbols for the SBFD communications as corresponding to both of the SBFD symbols and the non-SBFD symbols, receiving second information that configures a first set of multiple semi-persistent scheduling physical downlink shared channel (SPS-PDSCH) messages, receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages, and selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type.

A UE for wireless communications is described. The UE may include one or more memories storing processor executable code, and one or more processors coupled with the one or more memories. The one or more processors may individually or collectively be operable to execute the code to cause the UE to receive first information that configures the UE for communications via SBFD symbols and via non-SBFD symbols in accordance with a first configuration for SBFD communications or a second configuration for SBFD communications, where the first configuration for SBFD communications defines valid symbols for the SBFD communications as corresponding to one of the SBFD symbols or the non-SBFD symbols, and where the second configuration for SBFD communications defines valid symbols for the SBFD communications as corresponding to both of the SBFD symbols and the non-SBFD symbols, receive second information that configures a first set of multiple SPS-PDSCH messages, receive third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages, and select one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type.

Another UE for wireless communications is described. The UE may include means for receiving first information that configures the UE for communications via SBFD symbols and via non-SBFD symbols in accordance with a first configuration for SBFD communications or a second configuration for SBFD communications, where the first configuration for SBFD communications defines valid symbols for the SBFD communications as corresponding to one of the SBFD symbols or the non-SBFD symbols, and where the second configuration for SBFD communications defines valid symbols for the SBFD communications as corresponding to both of the SBFD symbols and the non-SBFD symbols, means for receiving second information that configures a first set of multiple SPS-PDSCH messages, means for receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages, and means for selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type.

A non-transitory computer-readable medium storing code for wireless communications is described. The code may include instructions executable by one or more processors to receive first information that configures the UE for communications via SBFD symbols and via non-SBFD symbols in accordance with a first configuration for SBFD communications or a second configuration for SBFD communications, where the first configuration for SBFD communications defines valid symbols for the SBFD communications as corresponding to one of the SBFD symbols or the non-SBFD symbols, and where the second configuration for SBFD communications defines valid symbols for the SBFD communications as corresponding to both of the SBFD symbols and the non-SBFD symbols, receive second information that configures a first set of multiple SPS-PDSCH messages, receive third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages, and select one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type.

In some examples of the method, UEs, and non-transitory computer-readable medium described herein, the first symbol type associated with the first set of multiple SPS-PDSCH messages corresponds to a type of symbol in which an initial instance of the first set of multiple SPS-PDSCH messages may be scheduled and the type of symbol may be one of an SBFD symbol type or a non-SBFD symbol type.

In some examples of the method, UEs, and non-transitory computer-readable medium described herein, the one or more exclusion rules define that the individual SPS-PDSCH message may be excluded from monitoring in accordance with the first configuration for SBFD communications based on the second symbol type associated with the individual SPS-PDSCH message not matching the first symbol type.

Some examples of the method, UEs, and non-transitory computer-readable medium described herein may further include operations, features, means, or instructions for excluding the individual SPS-PDSCH message from monitoring in accordance with the first configuration for SBFD communications based on the first symbol type being the SBFD symbol type and the second symbol type being the non-SBFD symbol type, where association of the individual SPS-PDSCH message with the second symbol type may be based on the individual SPS-PDSCH message being scheduled for receipt during a symbol of the non-SBFD symbol type.

Some examples of the method, UEs, and non-transitory computer-readable medium described herein may further include operations, features, means, or instructions for excluding the individual SPS-PDSCH message from monitoring in accordance with the first configuration for SBFD communications based on the first symbol type being the non-SBFD symbol type and the second symbol type being the SBFD symbol type or a non-SBFD uplink symbol type, where association of the individual SPS-PDSCH message with the second symbol type may be based on the individual SPS-PDSCH message being scheduled for receipt during a symbol of the SBFD symbol type or during a symbol of the non-SBFD uplink symbol type.

Some examples of the method, UEs, and non-transitory computer-readable medium described herein may further include operations, features, means, or instructions for performing feedback generation for the first set of multiple SPS-PDSCH messages, where generating an acknowledgment feedback bit for the individual SPS-PDSCH message may be based on the second symbol type associated with the individual SPS-PDSCH message.

In some examples of the method, UEs, and non-transitory computer-readable medium described herein, the one or more exclusion rules define that the individual SPS-PDSCH message may be excluded from feedback generation in accordance with the first configuration for SBFD communications based on the second symbol type associated with the individual SPS-PDSCH message not matching the first symbol type.

Some examples of the method, UEs, and non-transitory computer-readable medium described herein may further include operations, features, means, or instructions for excluding the individual SPS-PDSCH message from feedback generation in accordance with the first configuration for SBFD communications based on the first symbol type being the SBFD symbol type and the second symbol type being the non-SBFD symbol type, where association of the individual SPS-PDSCH message with the second symbol type may be based on the individual SPS-PDSCH message being scheduled for receipt during a symbol of the non-SBFD symbol type.

Some examples of the method, UEs, and non-transitory computer-readable medium described herein may further include operations, features, means, or instructions for excluding the individual SPS-PDSCH message from feedback generation in accordance with the first configuration for SBFD communications based on the first symbol type being the SBFD symbol type and the second symbol type being the non-SBFD symbol type, where association of the individual SPS-PDSCH message with the second symbol type may be based on the individual SPS-PDSCH message being scheduled for receipt during a symbol of the non-SBFD symbol type.

Some examples of the method, UEs, and non-transitory computer-readable medium described herein may further include operations, features, means, or instructions for excluding the individual SPS-PDSCH message from monitoring based on the second symbol type being corresponding to both of the SBFD symbol type and the non-SBFD symbol type, where association of the second symbol type of the individual SPS-PDSCH message with both of the SBFD symbol type and the non-SBFD symbol type the second symbol type may be based on the individual SPS-PDSCH message being scheduled for receipt during both of a symbol of the SBFD symbol type and a symbol of the non-SBFD symbol type.

Some examples of the method, UEs, and non-transitory computer-readable medium described herein may further include operations, features, means, or instructions for excluding the individual SPS-PDSCH message from feedback generation based on the second symbol type being corresponding to both of the SBFD symbol type and the non-SBFD symbol type, where association of the second symbol type of the individual SPS-PDSCH message with both of the SBFD symbol type and the non-SBFD symbol type the second symbol type may be based on the individual SPS-PDSCH message being scheduled for receipt during both of a symbol of the SBFD symbol type and a symbol of the non-SBFD symbol type.

In some examples of the method, UEs, and non-transitory computer-readable medium described herein, the first symbol type and the second symbol type correspond to one of the SBFD symbol type or the non-SBFD symbol type in accordance with the first configuration for SBFD communications.

### BRIEF DESCRIPTION OF THE DRAWINGS

FIG. 1 shows an example of a wireless communication system.

FIG. 2 shows an example of a signaling diagram that supports shared channel collision resolution and hybrid automated repeat request for semi persistent scheduling in sub-band full duplex.

FIG. 3 shows an example of a slot structure that supports shared channel collision resolution and hybrid automated repeat request for semi persistent scheduling in sub-band full duplex.

FIG. 4 shows an example of a slot structure that supports shared channel collision resolution and hybrid automated repeat request for semi persistent scheduling in sub-band full duplex.

FIG. 5 shows an example of a process flow that supports shared channel collision resolution and hybrid automated repeat request for semi persistent scheduling in sub-band full duplex.

FIG. 6 shows a block diagram of a processing system that supports shared channel collision resolution and hybrid automated repeat request for semi persistent scheduling in sub-band full duplex.

FIG. 7 shows a diagram of a system including a device that supports shared channel collision resolution and hybrid automated repeat request for semi persistent scheduling in sub-band full duplex.

FIGS. 8 through 11 show flowcharts illustrating methods that support shared channel collision resolution and hybrid automated repeat request for semi persistent scheduling in sub-band full duplex.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) and a network entity may communicate according to a sub-band full duplex (SBFD) communication scheme, which may include one or more SBFD symbols, one or more non-SBFD symbols, or both. In some examples, the UE and the network entity may communicate one or more semi-persistent scheduling physical downlink shared channel (SPS-PDSCH) messages according to the SBFD communication scheme. Additionally, or alternatively, the one or more SPS-PDSCH messages may correspond to a symbol type (e.g., a valid symbol type), where individual instances of the one or more SPS-PDSCH messages are allowed to be received on one type of symbol (e.g., SBFD symbols or non-SBFD symbols). If so limited, then the SPS-PDSCH messages may be referred to as SBFD SPS-PDSCH messages or non-SBFD SPS-PDSCH messages. In other examples, SPS-PDSCH messages may be allowed to be received on a mixture of symbol types.

In such examples, different SPS-PDSCH messages (e.g., separately scheduled or configured SPS-PDSCH messages) may overlap (e.g., collide), where collision occurs when the different SPS-PDSCH messages are both scheduled to be received during some overlapping symbol or duration of time. When a collision is determined, the UE may perform a collision resolution procedure to determine one or more SPS-PDSCH messages to receive and one or more SPS-PDSCH messages to exclude from reception (e.g., to ignore). Additionally, or alternatively, the UE may determine, based on performing the collision resolution procedure, whether to generate feedback for the one or more SPS-PDSCH messages. However, the UE may be unaware of which SPS-PDSCH messages of the one or more SPS-PDSCH messages to exclude from reception, feedback generation, or both based on the SPS-PDSCH messages corresponding to the SBFD communication scheme. Current collision resolution procedures do not account for the scheduling of SPS-PDSCH messages on different symbol types.

Aspects of the subject matter described in this disclosure relate to shared channel collision resolution and hybrid automated repeat request (HARQ) for SPS in SBFD. For example, according to one or more techniques described herein, the UE may determine whether to exclude one or more SPS-PDSCH messages of the one or more overlapping SPS-PDSCH messages based on one or more exclusion rules. For example, the UE may exclude (e.g., refrain from receiving or refrain from generating feedback for) an SBFD SPS-PSDCH message that overlaps with one or more non-SBFD symbols, or the UE may exclude a non-SBFD SPS-PDSCH message that overlaps with one or more SBFD symbols. Additionally, or alternatively, the UE may exclude one or more SPS-PDSCH messages (e.g., SBFD SPS-PDSCH messages or non-SBFD SPS-PDSCH messages) that overlap with both SBFD symbols and non-SBFD symbols.

For example, the network entity may schedule a SPS-PDSCH message during both of a SBFD symbol and a non-SBFD symbol (e.g., mapped to both of the SBFD symbol and the non-SBFD symbol), and the UE may accordingly exclude the SPS-PDSCH message from reception (e.g., monitoring), feedback generation, or both in accordance with the one or more exclusion rules. For example, the network entity may schedule (e.g., according to a network scheduling parameter) a SPS-PDSCH message (e.g., an individual SPS-PDSCH message of a series of SPS-PDSCH messages) during both of the SBFD symbol and a non-SBFD symbol. Accordingly, the network entity may refrain from transmitting the scheduled SPS-PDSCH message (e.g., according to the one or more exclusion rules). Additionally, or alternatively, in examples where the network entity may transmit the SPS-PDSCH message, the UE may refrain from monitoring for (e.g., ignore) the SPS-PDSCH message. In some examples, the UE may, based on excluding one or more SPS-PDSCH messages, perform the collision resolution procedure and receive one or more non-excluded SPS-PDSCH messages (e.g., surviving SPS-PDSCH messages).

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from reception, feedback generation, or both, the UE may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, among other advantages. Additionally, or alternatively, selecting a set of SPS-PDSCH messages to include in the feedback generation (e.g., HARQ codebook generation) according to the symbol type of the SPS-PDSCH messages may result in a more efficient utilization of communication resources (e.g., HARQ feedback resources), may improve downlink scheduling, may improve resource allocation efficiency, and may improve spectral efficiency, among other advantages.

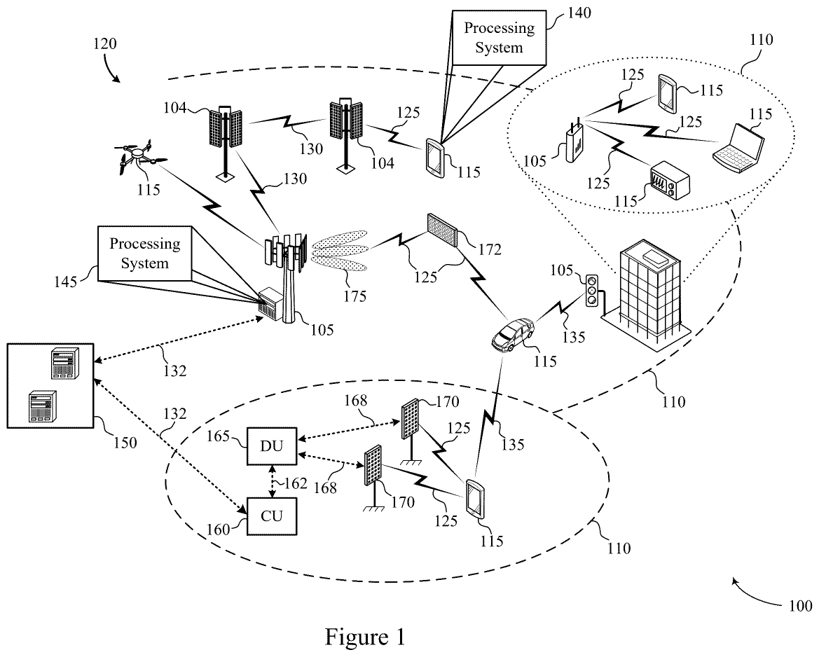

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for shared channel collision resolution and HARQ for SPS in SBFD. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support shared channel collision resolution and HARQ for SPS in SBFD. For example, according to one or more techniques described herein, the UE 115 may determine whether to exclude one or more SPS-PDSCH messages of the one or more overlapping SPS-PDSCH messages based on one or more exclusion rules. For example, the UE 115 may exclude (e.g., refrain from monitoring or refrain from generating feedback for) a SBFD SPS-PSDCH message that overlaps with one or more non-SBFD symbols, or the UE 115 may exclude a non-SBFD SPS-PDSCH message that overlaps with one or more SBFD symbols. Additionally, or alternatively, the UE 115 may exclude one or more SPS-PDSCH messages (e.g., SBFD SPS-PDSCH messages or non-SBFD SPS-PDSCH messages) that overlap with both SBFD symbols and non-SBFD symbols. For example, the network entity 105 may schedule a SPS-PDSCH message during both of a SBFD symbol and a non-SBFD symbol (e.g., mapped to both of the SBFD symbol and the non-SBFD symbol), and the UE 115 may accordingly exclude the SPS-PDSCH message from reception (e.g., monitoring based on not anticipating a transmission of the SPS-PDSCH message), feedback generation, or both in accordance with the one or more exclusion rules. In some examples, the UE 115 may, based on excluding one or more SPS-PDSCH messages, perform the collision resolution procedure and receive one or more non-excluded SPS-PDSCH messages (e.g., surviving SPS-PDSCH messages).

In some examples, the network entity 105 may operate according to the exclusion rules. In such examples, the network entity 105 may refrain from transmitting a scheduled SPS-PDSCH message according to the exclusion rules and on the SPS-PDSCH message being scheduled during one or more symbol types different from the symbol type of the SPS-PDSCH message, among other examples. Additionally, or alternatively, the UE 115 may refrain from monitoring for, or receiving (e.g., ignoring), the SPS-PDSCH message according to the exclusion rules.

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from reception, feedback generation, or both, the UE 115 may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, a more efficient utilization of communication resources, and a more efficient retransmission procedure, among other advantages.

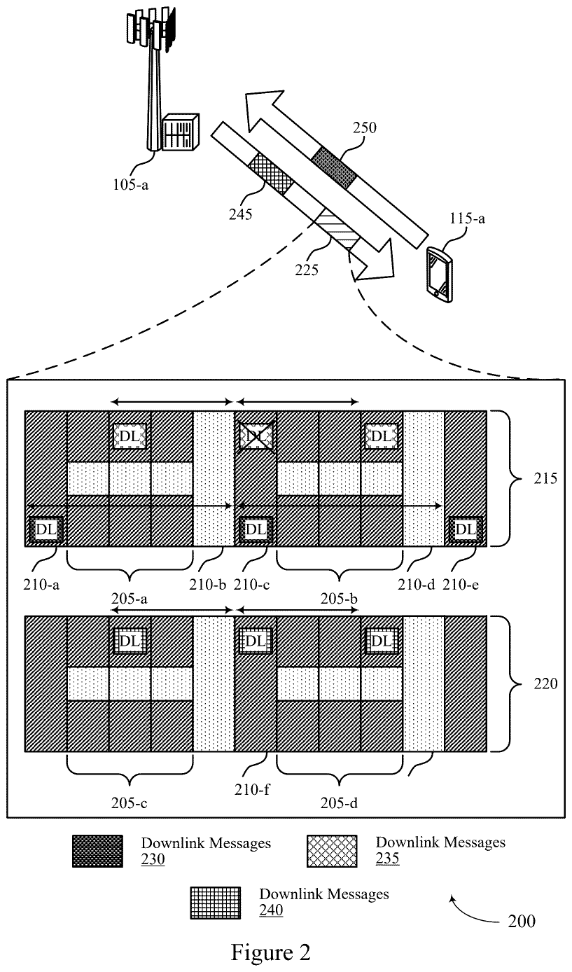

FIG. 2 shows an example of a signaling diagram 200 that supports shared channel collision resolution and HARQ for SPS in SBFD. Aspects of the signaling diagram 200 may implement or be implemented by one or more aspects of the wireless communication system 100. For example, the signaling diagram 200 may include a UE 115-a and a network entity 105-a, which may be examples of the UE 115 and the network entity 105, respectively.

In some cases, the UE 115-a and the network entity 105-a may communicate according to one or more full duplex (FD) communication schemes. For example, the network entity 105-a and the UE 115-a may communicate according to an in-band full duplex (IBFD) scheme. Accordingly, the network entity 105-a and the UE 115-a may transmit and receive via a same time and frequency resource (e.g., a same set of communication resources), such that downlink communications and uplink communications share the same IBFD time/frequency resource (e.g., a full/partial overlap). Additionally, or alternatively, the network entity 105-a and the UE 115-a may communicate according to a SBFD scheme (e.g., flexible duplex). Accordingly, the network entity 105-a and the UE 115-a may transmit and receive at the same time via different frequency resources such that downlink resources are separated from uplink resources in the frequency domain (e.g., non-overlapping uplink and downlink subbands), which may be separated by a guard band. In some cases, the network entity 105-a may communicate according to the SBFD scheme while the UE 115-a may communicate according to a half-duplex scheme (e.g., the UE 115-a may either transmit or receive at a given time).

In some cases, the network entity 105-a and the UE 115-a may communicate one or more SBFD communications across a set of symbols including both SBFD symbols 205 and non-SBFD symbols 210. In such cases, the UE 115-a (e.g., a SBFD aware UE) may receive an indication of a configuration for uplink transmissions and downlink receptions across SBFD symbols 205 and non-SBFD symbols 210 in different slots (e.g., each transmission/reception within a slot has either SBFD or non-SBFD symbols). For example, the UE 115-a may receive an indication of, and may operate according to, a first configuration 215 (e.g., Configuration 1) or a second configuration 220 (e.g., Configuration 2). According to the first configuration 215, the UE 115-a may communicate transmissions and receptions via SBFD symbols 205 or non-SBFD symbols 210 (e.g., restricted to SBFD symbols 205 or non-SBFD symbols 210). Additionally, or alternatively, according to the second configuration 220, the UE 115-a may communicate transmissions and receptions via both SBFD symbols 205 and non-SBFD symbols 210.

In some cases, the UE 115-a may receive the indication of (e.g., and may operate according to) the second configuration 220 for one or more communication bands or communication bandwidth parts (BWP) associated with uplink communications, downlink communications, or both (e.g., a per uplink/downlink BWP basis). For example, the UE 115-a may receive the indication of the second configuration 220 for one or more downlink BWPs associated with PDSCH receptions (e.g., within the downlink BWP), and for one or more uplink BWPs associated with PUCCH and PUSCH transmissions (e.g., within the uplink BWP). Additionally, or alternatively, the UE 115-a may operate according to the first configuration 215 for communicating SRSs (e.g., Configuration 1 is applicable). In such cases, the UE 115-a may receive the indication of (e.g., and may operate according to) the second configuration 220 based on a capability of the UE 115-a (e.g., Configuration 1 is the default capability and support of Configuration 2 is subject to UE capability).

In some cases, the UE 115-a may operate according to the first configuration 215 (e.g., Configuration 1), and the UE 115-a may correspondingly communicate transmissions and receptions via one of the SBFD symbols 205 or the non-SBFD symbols 210 according to a valid symbol type. In some cases, the UE 115-a may receive an indication of the valid symbol type via control signaling (e.g., explicitly configured via RRC signaling), which may indicate one of the SBFD symbols 205 or the non-SBFD symbols 210 for communication of semi-statically configured communications (e.g., transmissions/receptions without activation DCI not including PDCCH messages including persistent or semi-persistent SRS (P/SP-SRS), P/SP CSI reporting, P/SP CSI-RS, or configured grant (CG) Type 1 communications).

Additionally, or alternatively, the UE 115-a may perform dynamically scheduled transmissions and receptions (e.g., shared channel communications, PUCCH repetitions, and multiple shared channel communications scheduled by a single DCI). Accordingly, the UE 115-a may determine the valid symbol type for communications according to the first configuration 215 based on a symbol type of a first communication (e.g., transmission/reception) occasion indicated by a scheduling DCI. For example, the UE 115-a may receive a DCI scheduling a set of PUSCH messages, and the UE 115-a may determine a symbol type (e.g., SBFD symbols 205 or non-SBFD symbols 210) for one or more subsequent PUSCH messages of the set of PUSCH messages based on a symbol type of a first PUSCH message of the set of PUSCH messages (e.g., the first PUSCH message indicated by the scheduling DCI may not be mapped to both SBFD and non-SBFD symbols 210).

Additionally, or alternatively, the UE 115-a may perform semi-persistent transmissions and receptions (e.g., CG Type 2 PUSCH, or SPS-PDSCH messages 225). Accordingly, the UE 115-a may determine a valid symbol type (e.g., for Type 2 CG PUSCH or SPS-PDSCH) based on the symbol type of a first communication of the semi-persistent transmissions and receptions indicated by an activation DCI. For example, the UE 115-a may receive signaling configuring the UE 115-a with a set of resources for the semi-persistent communications. The UE 115-a may subsequently receive an activation DCI indicating for the UE 115-a to communicate according to the semi-persistent communications, and the DCI may indicate a first instance of the semi-persistent communications. In such examples, the UE 115-a may determine a symbol type (e.g., SBFD symbols 205 or non-SBFD symbols 210) based on the indicated first semi-persistent communication (e.g., the first CG Type 2 PUSCH or SPS-PDSCH). For example, the UE 115-a may determine ethe symbol type based on a symbol type during which the first semi-persistent communication is scheduled (e.g., scheduled by the DCI).

For an illustrative example, the UE 115-a may operate according to the first configuration 215. In such examples, the UE 115-a may receive an indication of one or more downlink messages 230, which may be SPS communications (e.g., the UE 115-a may be configured with a series of the one or more downlink messages 230). The network entity 105-a may transmit, and the UE 115-a may receive, a first downlink message 230 of the one or more downlink messages 230 during a non-SBFD symbol 210-a (e.g., a non-SBFD downlink symbol). Accordingly, the UE 115-a may determine (e.g., assign) a valid symbol type of the one or more downlink messages 230 as the non-SBFD symbols 210, and the UE 115-a may correspondingly receive one or more second downlink messages 230 during the non-SBFD symbols 210. For example, the network entity 105-a may schedule (e.g., and transmit), and the UE 115-a may receive, one or more downlink messages 230 during a non-SBFD symbol 210-c and a non-SBFD symbol 210-e. The network entity 105-a and the UE 115-a may refrain from communicating the one or more downlink messages 230 during a non-SBFD symbol 210-b and a non-SBFD symbol 210-d (e.g., non-SBFD uplink symbols). Additionally, or alternatively, the network entity 105-a and the UE 115-a may refrain from communicating the one or more downlink messages 230 during the SBFD symbols 205.

For another illustrative example, the UE 115-a may receive an indication of one or more downlink messages 235, which may be an example of SPS communications (e.g., the UE 115-a may be configured with a series of SPS communications). In some examples, the network entity 105-a may transmit, and the UE 115-a may receive, a first downlink message 235 of the one or more downlink messages 235 during a SBFD symbol of a set of SBFD symbols 205-a. Accordingly, the UE 115-a may determine a valid symbol type of the one or more downlink messages 235 as the SBFD symbols 205, and the UE 115-a may correspondingly receive one or more second downlink messages 235 during SBFD symbols 205. For example, the UE 115-a may receive a second downlink message 235 during a SBFD symbol of a set of SBFD symbols 205-b. In some examples, the network entity 105-a may refrain from transmitting the one or more second downlink messages 235 during the non-SBFD symbols 210 such as during the non-SBFD symbol 210-c (e.g., according to the first configuration 215).

In another illustrative example, the UE 115-a may operate according to the second configuration 220. In such examples, the UE 115-a may receive an indication of one or more downlink messages 240, which may be SPS communications (e.g., the UE 115-a may be configured with a series of the one or more downlink messages 240). The network entity 105-a may transmit, and the UE 115-a may receive, a first downlink message 240 of the one or more downlink messages 240 during a SBFD symbol of a set of SBFD symbols 205-c, and the UE 115-a may correspondingly receive one or more second downlink messages 240 during the SBFD symbols 205, the non-SBFD symbols 210, or both based on the UE 115-a operating according to the second configuration 220. For example, the network entity 105-a may schedule (e.g., and transmit), and the UE 115-a may receive, one or more downlink messages 240 during a non-SBFD symbol 210-f and a SBFD symbol of a set of SBFD symbols 205-d (e.g., SBFD symbols and non-SBFD symbols according to the second configuration 220).

In some cases, the network entity 105-a and the UE 115-a may communicate the one or more SPS-PDSCH messages 225. For example, the UE 115-a may receive the SPS-PDSCH messages 225 and may generate feedback (e.g., HARQ) for the SPS-PDSCH messages 225. In some cases, the UE 115-a may refrain from monitoring or refrain from generating feedback for (e.g., exclude) the one or more SPS-PDSCH messages 225 during some symbol types (e.g., uplink symbols).

In some cases, the UE 115-a may refrain from monitoring or refrain from generating feedback for the one or more SPS-PDSCH messages 225 during a SBFD operation according to a symbol type of the one or more SPS-PDSCH messages 225 (e.g., the valid symbol type corresponding to the SBFD symbols 205 or the non-SBFD symbols 210) as well as a SBFD configuration of uplink and downlink transmissions across different slots. For example, the UE 115-a may exclude one or more of the one or more SPS-PDSCH messages 225 based on multiple SPS-PDSCH messages 225 overlapping (e.g., a collision) in a slot, overlapping with invalid symbol type (e.g., a symbol type different than the valid symbol type of the one or more SPS-PDSCH messages 225), or both. Additionally, or alternatively, the UE 115-a may exclude one or more of the one or more SPS-PDSCH messages 225 from Type-1 HARQ-ACK codebook construction based on an invalid symbol type of the one or more SPS-PDSCH messages 225.

In some cases, the UE 115-a may perform a collision resolution procedure based on the one or more SPS-PDSCH messages 225 overlapping. For example, the UE 115-a may perform the collision resolution procedure based on more than one PDSCH on a serving cell without a corresponding PDCCH transmission (e.g., SPS-PDSCH messages 225) being scheduled during a slot. In some cases, the UE 115-a may exclude one or more of the one or more SPS-PDSCH messages 225 from monitoring, feedback generation, or both according symbols in the slot being indicated as uplink symbols (e.g., slots indicated as being uplink symbols by tdd-UL-DL-ConfigurationCommon, or by tdd-ULDL-ConfigurationDedicated). For example, the UE 115-a may exclude the one or more SPS-PDSCH messages 225 based on the one or more SPS-PDSCH messages 225 being scheduled during uplink symbols. Additionally, or alternatively, the UE 115-a may exclude the one or more SPS-PDSCH messages 225 during non-active periods of a cell discontinuous transmission (DTX) cycle (e.g., if the serving cell is activated with cell DTX).

In some cases, the UE 115-a may receive the one or more SPS-PDSCH messages 225 (e.g., one or more PDSCHs without corresponding PDCCH transmissions) in the slot according to the collision resolution procedure. For example, the UE 115-a may (e.g., at Step 0), set j=0, where j is the number of selected PDSCH(s) for decoding, and Q is the set of activated PDSCHs without corresponding PDCCH transmissions within the slot (e.g., a quantity of the one or more SPS-PDSCH messages 225). The UE 115-a may (e.g., at Step 1) receive one of the one or more SPS-PDSCH messages 225 with a lowest configured sps-ConfigIndex within Q, and may set j=j+1 (e.g., the UE 115-a may designate the received SPS-PDSCH message 225 as survivor PDSCH). The UE 115-a may (e.g., at Step 2) exclude the survivor PDSCH (e.g., in Step 1) and any other PDSCH(s) overlapping (e.g., overlapping, or partially overlapping) with the survivor PDSCH from Q. The UE 115-a may (e.g., in Step 3) repeat Step 1 and 2 until Q is empty or j is equal to the number of the one or more SPS-PDSCH messages 225 (e.g., unicast PDSCHs in a slot supported by the UE).

The techniques, methods, and devices described herein may support shared channel collision resolution and HARQ for SPS in SBFD. For example, the UE 115-a may determine one or more of the one or more SPS-PDSCH messages 225 to exclude from monitoring, feedback generation, or both according to one or more exclusion rules (e.g., before performing the collision resolution procedure).

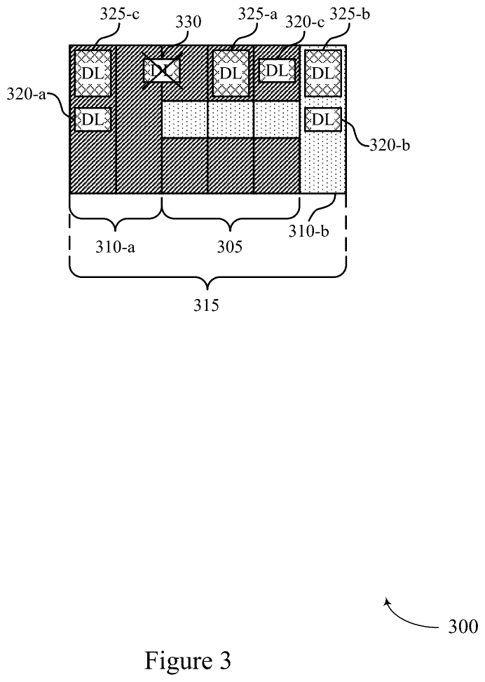

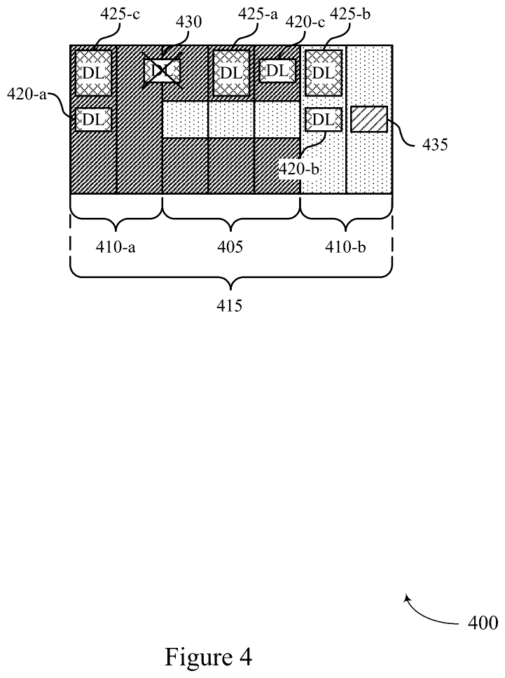

In some implementations, the UE may operate according to a first configuration (e.g., Configuration 1 for PDSCH reception) or a second configuration (e.g., Configuration 2) corresponding to a SBFD serving cell. For example, the UE may perform communications via a set of SBFD symbols, a set of non-SBFD symbols, or both. In such examples, the network entity may transmit, and the UE may receive, information 245 configuring the UE with semi-static communications (e.g., SPS-PDSCH communications) per downlink bandwidth part (DL-BWP). Accordingly, the UE may exclude one or more SPS-PDSCH messages 225 from monitoring (e.g., monitoring for reception) according to one or more techniques further described herein with reference to FIG. 3 (e.g., according to one or more exclusion rules. The network entity 105-a may refrain from transmitting one or more SPS-PDSCH messages 225 (e.g., scheduled SPS-PDSCH messages 225) according to one or more techniques further described herein with reference to FIG. 3 (e.g., according to one or more exclusion rules). Additionally, or alternatively, the UE may exclude one or more SPS-PDSCH messages 225 from feedback generation according to one or more techniques further described herein with reference to FIG. 4. The UE may subsequently perform a procedure for collision handling among the remaining SPS-PDSCH messages 225 for resolving overlapping SPS-PDSCH messages 225 in a slot (e.g., collision handling between multiple SPS-PDSCHs). In some examples, the UE 115-a may generate feedback information associated with the SPS-PDSCH messages 225 and may transmit a feedback report 250 via a PUCCH message, or the like.

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from reception, feedback generation, or both, the UE 115-a may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, among other advantages.

FIG. 3 shows an example of a slot structure 300 that supports shared channel collision resolution and HARQ for SPS in SBFD. Aspects of the slot structure 300 may implement or be implemented by one or more aspects of the wireless communication system 100, the signaling diagram 200, or both. For example, the slot structure 300 may be implemented between the UE, which may be an example of the UE 115, the UE 115-a, or both, and a network entity, which may be an example of the network entity 105, the network entity 105-a, or both.

In some implementations, the UE may operate according to a first configuration (e.g., Configuration 1 for PDSCH reception) corresponding to a SBFD serving cell. For example, the UE may perform communications via a set of SBFD symbols 305, a set of non-SBFD symbols 310, or both. In such examples, the network entity may transmit, and the UE may receive, information configuring the UE with semi-static communications (e.g., SPS-PDSCH communications) per downlink bandwidth part (DL-BWP). Accordingly, the UE may exclude one or more SPS-PDSCH messages from monitoring (e.g., monitoring for reception), feedback generation, or both. The UE may subsequently perform a procedure for collision handling (e.g., the collision resolution procedure further described herein with reference to FIG. 2) among the remaining SPS-PDSCH messages for resolving overlapping SPS-PDSCH messages in a slot 315 (e.g., collision handling between multiple SPS-PDSCHs). In some examples, the slot 315 may include SBFD symbols 305, non-SBFD symbols 310, or SBFD symbols 305 and non-SBFD symbols 310 (e.g., mixed SBFD and non-SBFD symbols slot).

In some implementations, the UE may exclude one or more SBFD SPS-PDSCH messages 320 (e.g., SBFD-specific) overlapping with the set of non-SBFD symbols 310 (e.g., non-SBFD DL/FL/UL symbols) in the slot 315. For example, the network entity may schedule a SBFD SPS-PDSCH message 320-a during a non-SBFD slot of a set of non-SBFD symbols 310-a, and the UE may exclude the SBFD SPS-PDSCH message 320-a based on the SBFD SPS-PDSCH message 320-a corresponding to the set of SBFD symbols 305 (e.g., a valid symbol type of corresponding to the set of SBFD symbols 305) and overlapping with the set of non-SBFD symbols 310-a. In some examples, a symbol type (e.g., a valid symbol type) of the SBFD SPS-PDSCH message 320-a may correspond to the set of SBFD symbols 305 according to one or more techniques further described herein with reference to FIG. 2.

In some implementations, the UE may exclude one or more non-SBFD SPS-PDSCH messages 325 overlapping with the set of SBFD symbols 305 or non-SBFD UL symbols in the slot 315. For example, the network entity may schedule a non-SBFD SPS-PDSCH message 325-a during the set of SBFD symbols 305, and the UE may exclude the non-SBFD SPS-PDSCH message 325-a based on the non-SBFD SPS-PDSCH message 325-a corresponding to the set of non-SBFD symbols 310 (e.g., a valid symbol type of corresponding to the set of non-SBFD symbols 310) and overlapping with the set of SBFD symbols 305.

Additionally, or alternatively, the network entity may schedule a non-SBFD SPS-PDSCH message 325-b during a non-SBFD uplink symbol 310-b, and the UE may exclude the non-SBFD SPS-PDSCH message 325-b based on the non-SBFD SPS-PDSCH message 325-b being scheduled during an uplink symbol (e.g., the non-SBFD uplink symbol 310-b). In some examples, a symbol type of the non-SBFD SPS-PDSCH message 325-a, the non-SBFD SPS-PDSCH message 325-b, or both may correspond to the set of non-SBFD symbols 310 according to one or more techniques further described herein with reference to FIG. 2. Additionally, or alternatively, the UE may exclude a SBFD SPS-PDSCH message 320-b based on the SBFD SPS-PDSCH message 320-b being scheduled during the non-SBFD uplink symbol 310-b (e.g., an uplink symbol).

In some implementations, the UE may exclude one or more SPS-PDSCH messages 330 overlapping with the set of SBFD symbols 305 and the set of non-SBFD symbols 310. For example, the network entity may schedule a SPS-PDSCH message 330 (e.g., a SBFD SPS-PDSCH message or a non-SBFD SPS-PDSCH message) during a SBFD symbol of the set of SBFD symbols 305 and during a non-SBFD slot of a set of non-SBFD symbols 310-a, and the UE may exclude the SPS-PDSCH message 330 based on the SPS-PDSCH message 330 overlapping with both of the set of SBFD symbols 305 and the set of non-SBFD symbols 310 (e.g., mapped across SBFD and non-SBFD symbols).

In some implementations, the network entity may schedule (e.g., semi-statically configure) a SBFD SPS-PDSCH message 320-c during the set of SBFD symbols 305 and a non-SBFD SPS-PDSCH message 325-c during a non-SBFD symbol of the set of non-SBFD symbols 310-a. In such implementations, the UE may select the SBFD SPS-PDSCH message 320-c, the non-SBFD SPS-PDSCH message 325-c, or both for reception based on the SBFD SPS-PDSCH message 320-c and the non-SBFD SPS-PDSCH message 325-c being scheduled during respective corresponding slot types of the set of SBFD symbols 305 or the set of non-SBFD symbols 310 (e.g., valid slot types, or valid downlink slot types). For example, the UE may include the SBFD SPS-PDSCH message 320-c in the collision resolution procedure further described herein with reference to FIG. 2 based on the SBFD SPS-PDSCH message 320-c being scheduled during the set of SBFD symbols 305, and the UE may include the non-SBFD SPS-PDSCH message 325-c in the collision resolution procedure based on the non-SBFD SPS-PDSCH message 325-c being scheduled during the set of non-SBFD symbols 310.

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from reception, the UE may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, among other advantages.

FIG. 4 shows an example of a slot structure 400 that supports shared channel collision resolution and HARQ for SPS in SBFD. Aspects of the slot structure 400 may implement or be implemented by one or more aspects of the wireless communication system 100, the signaling diagram 200, or both. For example, the slot structure 400 may be implemented between the UE, which may be an example of the UE 115, the UE 115-a, or both, and a network entity, which may be an example of the network entity 105, the network entity 105-a, or both.

In some cases, the network entity may transmit information configuring the UE with SPS communications (e.g., SPS-PDSCH receptions). For example, the UE may receive information indicating SPS-PDSCH receptions associated with a SPS-PDSCH configuration, and the network entity may activate the SPS PDSCH receptions via a DCI message (e.g., by a DCI format with cyclic redundancy check (CRC) scrambled by a configured scheduling radio network temporary identifier (CS-RNTI) or by a DCI format with CRC scrambled by a group common scheduling RNTI (G-CS-RNTI)). In some cases, the UE may perform feedback generation for the SPS-PDSCH receptions including HARQ acknowledgment (ACK) (e.g., Type-I HARQ-ACK codebook determination). In such cases, the UE may set a value

$${N}_{cells}^{DL}$$

to a quantity of serving cells configured to the UE, set a value

$${N}_{C}^{SPS}$$

to a quantity of SPS-PDSCH configurations configured to the UE (e.g., for a serving cell c), and set a value

$${N}_{C}^{DL}$$

to the number of downlink slots for SPS-PDSCH receptions on a serving cell (e.g., serving cell c) with HARQ-ACK information multiplexed on a PUCCH. Accordingly, the UE may perform feedback generation according to at least the values

$${N}_{cells}^{DL} , {N}_{C}^{SPS} , and {N}_{C}^{DL} .$$

In some cases, the UE may receive information indicating a SPS-PDSCH configuration (e.g., SPS-PDSCH configuration s on serving cell c) including SPS-PDSCH receptions from a first slot

$$( e . g . , {n}_{D} - {N}_{PDSCH}^{repeat} + 1 )$$

to a second slot (e.g., n_{D}). In some cases, the UE may exclude one or more SPS-PDSCHs from feedback generation that are not received in any slot among overlapping SPS-PDSCHs, or the UE may exclude the one or more SPS-PDSCHs based on a UE capability for a number of PDSCH receptions in a slot, or due to overlapping with a set of symbols (e.g., symbols indicated as uplink by tdd-UL-DL-ConfigurationCommon or by tdd-UL-DLConfigurationDedicated, and/or determined as non-active period of cell DTX). In such cases, for unicast SPS-PDSCHs, the UE may receive an indication of the quantity of slots including candidate SPS-PDSCH messages for feedback generation via one or more parameters (e.g.,

$${N}_{PDSCH}^{repeat}$$

is provided by pdsch-AggregationFactor-r16 in SPS-Config or, if pdsch-AggregationFactor-r16 is not included in SPS-Config, by pdschAggregationFactor in PDSCH-config and, for multicast SPS-PDSCHs,

$${N}_{PDSCH}^{repeat}$$

is provided by repetitionNumber if contained in an entry indicated by the time domain resource assignment field in the DCI format scheduling the PDSCH repetition, or provided by pdschAggregationFactor-r16 if included in SPS-Config or, otherwise,

$${N}_{PDSCH}^{repeat} = 1.$$

The UE may generate and transmit HARQ-ACK information for the SPS-PDSCH messages via a PUCCH, and the UE may include a HARQ-ACK information bit (e.g.,

$${\tilde{o}}_{j}^{ACK} )$$

for a SPS-PDSCH reception (e.g., j=j+1) within the HARQ-ACK information.

The techniques, methods, and devices described herein may support shared channel collision resolution and HARQ for SPS in SBFD. For example, the UE 115-a may determine one or more SPS-PDSCH messages to exclude from monitoring, feedback generation, or both according to one or more exclusion rules (e.g., before performing a collision resolution procedure further described herein with reference to FIG. 2).

In some implementations, the UE may receive information indicating the one or more SPS-PDSCH messages according to a SPS-PDSCH configuration. For example, the network may schedule SPS-PDSCH messages from a first slot (e.g., n_{D}−N) to a second slot (e.g., n_{D}) in a serving cell according to a SBFD configuration (e.g., an SBFD operation in the cell). In such examples, the UE may perform communications according to a set of SBFD symbols 405, a set of non-SBFD symbols 410, or both. Accordingly, the UE may determine (e.g., after performing a collision resolution procedure further described herein with reference to FIG. 2) a HARQ-ACK information bit for a SPS-PDSCH message scheduled during a slot 415 (e.g., n_{D}). In some examples, the UE may exclude one or more SPS-PDSCH messages from feedback generation (e.g., Type-I HARQ codebook construction) according to one or more exclusion rules, a symbol type of the SPS-PDSCH messages, or both.

In some implementations, the UE may operate according to a first configuration (e.g., Configuration 1 for downlink reception per DL-BWP), and the UE may exclude one or more SPS-PDSCH messages based at least on a valid symbol type of the SPS-PDSCH messages (e.g., Exclusion Rule #1). For example, the UE may exclude the SPS-PDSCH messages based on the SPS-PDSCH messages being scheduled during symbol types different from respective valid symbol types of the SPS-PDSCH messages (e.g., the SPS-PDSCH messages corresponding to an invalid duplex symbol type).

In some examples, the network entity may schedule a SBFD SPS-PDSCH message 420-a (e.g., SPS-PDSCH with SBFD valid symbol type) during a non-SBFD symbol of a set of non-SBFD symbols 410-a (e.g., an invalid symbol type) included in the slot 415, and the UE may correspondingly exclude the SBFD SPS-PDSCH message 420-a from feedback generation based on the symbol type of the SBFD SPS-PDSCH message 420-a corresponding to the set of SBFD symbols 405 according to one or more techniques further described herein with reference to FIG. 2 (e.g., UE excludes SPS-PDSCHs in invalid non-SBFD symbols). Additionally, or alternatively, the network entity may schedule, a SBFD SPS-PDSCH message 420-b (e.g., SPS-PDSCH with SBFD valid symbol type) during a non-SBFD uplink symbol 410-b, and the UE may correspondingly exclude the SBFD SPS-PDSCH message 420-b from feedback generation based on the symbol type of the SBFD SPS-PDSCH message 420-b corresponding to the set of SBFD symbols 405.

In some examples, the network entity may schedule a non-SBFD SPS-PDSCH message 425-a during a SBFD symbol of the set of SBFD symbols 405, and the UE may exclude the non-SBFD SPS-PDSCH message 425-a from feedback generation based on the symbol type of the non-SBFD SPS-PDSCH message 425-a corresponding to the set of non-SBFD symbols 410 while being scheduled during the set of SBFD symbols 405. Additionally, or alternatively, the network entity may schedule, a non-SBFD SPS-PDSCH message 425-b (e.g., SPS-PDSCH with non-SBFD valid symbol type) during a non-SBFD uplink symbol 410-b, and the UE may correspondingly exclude the non-SBFD SPS-PDSCH message 425-b from feedback generation based on the non-SBFD SPS-PDSCH message 425-b being scheduled during an uplink symbol (e.g., the non-SBFD uplink symbol 410-b).

In some examples, the UE may operate according to the first configuration (e.g., Configuration 1) or a second configuration (e.g., Configuration 2) further described herein with reference to FIG. 2. The network entity may schedule a SPS-PDSCH message 430 (e.g., a SBFD SPS-PDSCH or a non-SBFD SPS-PDSCH) during both of the set of SBFD symbols 405 and the set of non-SBFD symbols 410 (e.g., e.g., mapped across SBFD and non-SBFD symbols). The UE may exclude the SPS-PDSCH message 430 based on the SPS-PDSCH message 430 overlapping with both of the set of SBFD symbols 405 and the set of non-SBFD symbols 410 (e.g., Exclusion Rule #2).

In some implementations, the network entity may schedule (e.g., semi-statically configure) a SBFD SPS-PDSCH message 420-c during the set of SBFD symbols 405 and a non-SBFD SPS-PDSCH message 425-c during a non-SBFD symbol of the set of non-SBFD symbols 410-a. In such implementations, the UE may select the SBFD SPS-PDSCH message 420-c, the non-SBFD SPS-PDSCH message 425-c, or both for feedback generation based on the SBFD SPS-PDSCH message 420-c and the non-SBFD SPS-PDSCH message 425-c being scheduled during respective corresponding slot types of the set of SBFD symbols 405 or the set of non-SBFD symbols 410 (e.g., valid slot types, or valid downlink slot types). For example, the UE may include a HARQ-ACK information bit for the SBFD SPS-PDSCH message 420-c and for the non-SBFD SPS-PDSCH message 425-c based on the SBFD SPS-PDSCH message 420-c being scheduled during the set of SBFD symbols 405 and on the non-SBFD SPS-PDSCH message 425-c being scheduled during the set of non-SBFD symbols 410.

In some implementations, the UE may perform feedback generation according to one or more techniques described herein. For example, the UE may include a HARQ-ACK information bit for each selected SPS-PDSCH message within the slot 415 (e.g., non-excluded SPS-PDSCH messages) in the feedback generation. Accordingly, the UE may transmit a feedback report via a PUCCH message 435 (e.g., in a corresponding uplink symbol 410-b) based on performing the feedback generation.

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from feedback generation, the UE may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, among other advantages.

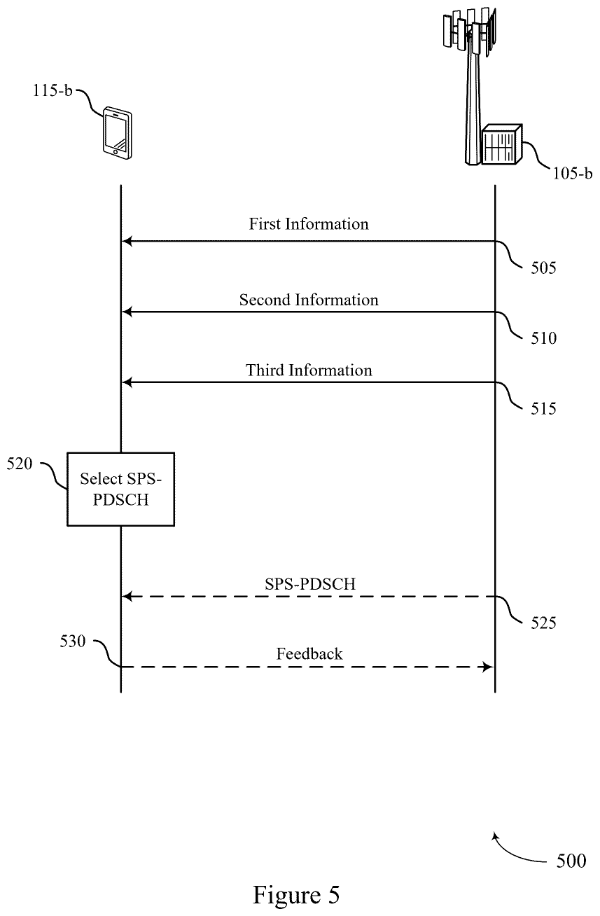

FIG. 5 shows an example of a process flow 500 that supports shared channel collision resolution and HARQ for SPS in SBFD. Aspects of the process flow 500 may implement or be implemented by aspects of the wireless communication system 100, the signaling diagram 200, or both. For example, the process flow 500 may include a UE 115-b, which may be an example of the UE 115 or the UE 115-a, and a network entity 105-b, which may be an example of the network entity 105 or the network entity 105-a.

In the following description of the process flow 500, the operations between the UE 115-b and the network entity 105-b may be performed in different orders or at different times. Some operations may also be left out of the process flow 500, or other operations may be added. Although the UE 115-b and the network entity 105-b are shown performing the operations of the process flow 500, some aspects of some operations may also be performed by one or more other wireless devices.

At 505, the network entity 105-b may transmit, and the UE 115-b may receive, first information (e.g., signaling, or configuration information) configuring the UE 115-b for communications via a set of SBFD symbols, a set of non-SBFD symbols, or both as further described herein with reference to FIG. 2. For example, the network entity 105-b may indicate, via the first information, a slot format including one or more SBFD symbols, one or more non-SBFD symbols, or both (e.g., according to a SBFD operation)

At 510, the network entity 105-b may transmit, and the UE 115-b may receive, second information (e.g., signaling, or configuration information) configuring a first set of SPS-PDSCH messages including at least one SPS-PDSCH message. In some examples, the network entity 105-b may transmit control signaling (e.g., a DCI message) activating the first set of SPS-PDSCH messages.

At 515, the network entity 105-b may transmit, and the UE 115-b may receive, third information (e.g., signaling, or configuration information) configuring a second set of SPS-PDSCH messages including at least one SPS-PDSCH message. In some examples, the network entity 105-b may transmit control signaling (e.g., a DCI message) activating the second set of SPS-PDSCH messages. In some examples, the network entity 105-b may schedule, via the second information, one or more SPS-PDSCH messages of the second set of SPS-PDSCH messages that overlap with one or more SPS-PDSCH messages of the first set of SPS-PDSCH messages. For example, one or more SPS-PDSCH messages may overlap in a slot. Accordingly, the UE 115-b may perform a collision resolution procedure further described herein with reference to FIG. 2 based on the one or more SPS-PDSCH messages overlapping in the slot.

At 520, the UE 115-b may select one or more SPS-PDSCH messages of the first set of SPS-PDSCH messages, the second set of SPS-PDSCH messages, or both for reception, feedback generation, or both according to the collision resolution procedure. For example, the UE 115-b may exclude one or more of the overlapping SPS-PDSCH messages in the slot according to one or more exclusion rules, and the UE 115-b may select one or more remaining (e.g., non-excluded) SPS-PDSCH messages for reception, feedback generation, or both. In such examples, the SPS-PDSCH messages may correspond to SBFD symbols or non-SBFD symbols, and the UE 115-b may exclude (e.g., exclude from selection based on the collision resolution procedure) the one or more overlapping SPS-PDSCH messages based on a symbol type (e.g., a valid symbol type) of the excluded SPS-PDSCH messages according to the exclusion rules and one or more techniques further described herein with reference to FIG. 3 and FIG. 4.

In some examples, at 525, the UE 115-b may receive one or more selected SPS-PDSCH messages (e.g., non-excluded SPS-PDSCH messages). For example, the UE 115-b may receive the selected SPS-PDSCH messages based on selecting the SPS-PDSCH messages from the first set of SPS-PDSCH messages, the second set of SPS-PDSCH messages, or both in accordance with the exclusion rules and the collision resolution procedure.

In some examples, at 530, the UE 115-b may transmit a feedback report corresponding to the overlapping SPS-PDSCH messages. The UE 115-b may transmit the feedback report via a PUCCH message. In some examples, the UE 115-b may transmit the feedback report based on generating the feedback report according to one or more techniques further described herein with reference to FIG. 4. For example, the UE 115-b may select one or more SPS-PDSCH messages of the first set of SPS-PDSCH messages, the second set of SPS-PDSCH messages, or both for feedback generation in accordance with the exclusion rules and the collision resolution procedure, and the UE 115-b may correspondingly include a HARQ-ACK information bit for each respective SPS-PDSCH message of the selected SPS-PDSCH messages in the feedback report. In such examples, the UE 115-b may include a respective HARQ-ACK information bit for one or more overlapping SPS-PDSCH messages received at 525, one or more SPS-PDSCH messages excluded from reception, or both.

Particular aspects of the subject matter described in this disclosure can be implemented to realize one or more of the following potential advantages. In some examples, by performing shared channel collision resolution and HARQ for SPS in SBFD, the described techniques can be used to realize one or more of the following potential advantages. By determining one or more SPS-PDSCH messages to exclude from feedback generation, the UE 115-b may reduce a quantity of SPS-PDSCH messages included in the collision resolution procedure (e.g., compared to performing the collision resolution procedure including each of the configured SPS-PDSCH messages), which may improve a processing efficiency associated with the collision resolution procedure, among other advantages.

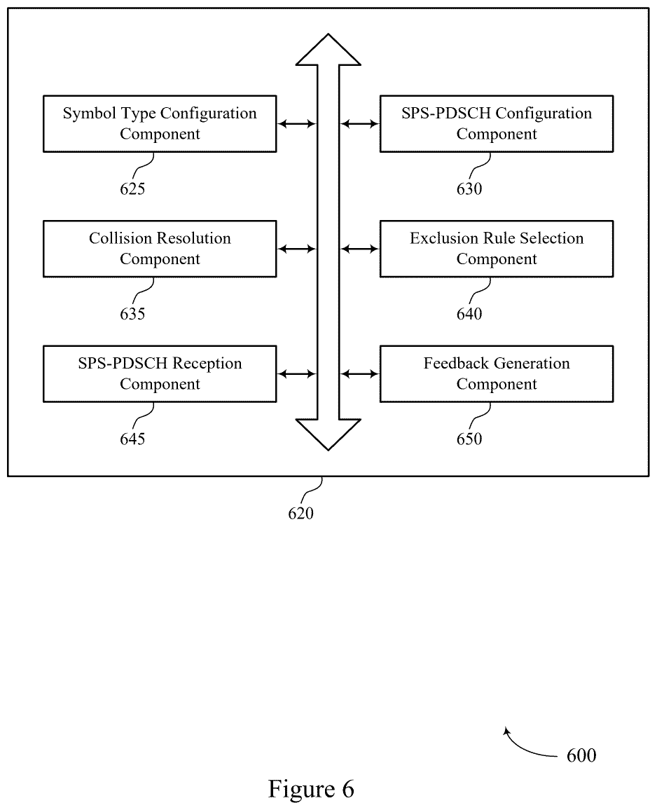

FIG. 6 shows an example of a processing system 620 that supports shared channel collision resolution and HARQ for SPS in SBFD. A processing system 620 may be an example of a processing system 140 (such as of a UE 115) and may include a symbol type configuration component 625, an SPS-PDSCH configuration component 630, a collision resolution component 635, an exclusion rule selection component 640, an SPS-PDSCH reception component 645, a feedback generation component 650, or any combination thereof. A processing system 620, or various component thereof, may be an example of means for performing (such as a means for causing a UE 115 to perform) various techniques described herein.

The symbol type configuration component 625 may be configured to cause the UE 115 to receive first information that configures the UE for communications via SBFD symbols and via non-SBFD symbols. The SPS-PDSCH configuration component 630 may be configured to cause the UE 115 to receive second information that configures a first set of multiple SPS-PDSCH messages. The collision resolution component 635 may be configured to cause the UE 115 to receive third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages. The exclusion rule selection component 640 may be configured to cause the UE 115 to select one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type.

In some examples, the first symbol type associated with the first set of multiple SPS-PDSCH messages corresponds to a type of symbol in which an initial instance of the first set of multiple SPS-PDSCH messages is scheduled. In some examples, the type of symbol is one of an SBFD symbol type or a non-SBFD symbol type.

In some examples, the one or more exclusion rules define that the individual SPS-PDSCH message is to be excluded from monitoring based on the second symbol type associated with the individual SPS-PDSCH message not matching the first symbol type.

In some examples, the SPS-PDSCH reception component 645 may be configured to cause the UE 115 to exclude the individual SPS-PDSCH message from monitoring based on the first symbol type being the SBFD symbol type and the second symbol type being the non-SBFD symbol type, where association of the individual SPS-PDSCH message with the second symbol type is based on the individual SPS-PDSCH message being scheduled for receipt during a symbol of the non-SBFD symbol type.

In some examples, the SPS-PDSCH reception component 645 may be configured to cause the UE 115 to exclude the individual SPS-PDSCH message from monitoring based on the first symbol type being the non-SBFD symbol type and the second symbol type being the SBFD symbol type or a non-SBFD uplink symbol type, where association of the individual SPS-PDSCH message with the second symbol type is based on the individual SPS-PDSCH message being scheduled for receipt during a symbol of the SBFD symbol type or during a symbol of the non-SBFD uplink symbol type.

In some examples, the feedback generation component 650 may be configured to cause the UE 115 to perform feedback generation for the first plurality of SPS-PDSCH messages, where generating an acknowledgment feedback bit for the individual SPS-PDSCH message is based on the second symbol type associated with the individual SPS-PDSCH message.

In some examples, the one or more exclusion rules define that the individual SPS-PDSCH message is to be excluded from feedback generation based on the second symbol type associated with the individual SPS-PDSCH message not matching the first symbol type.

In some examples, the feedback generation component 650 may be configured to cause the UE 115 to exclude the individual SPS-PDSCH message from feedback generation based on the first symbol type being the SBFD symbol type and the second symbol type being the non-SBFD symbol type, where association of the individual SPS-PDSCH message with the second symbol type is based on the individual SPS-PDSCH message being scheduled for receipt during a symbol of the non-SBFD symbol type.

In some examples, the feedback generation component 650 may be configured to cause the UE 115 to exclude the individual SPS-PDSCH message from feedback generation based on the first symbol type being the SBFD symbol type and the second symbol type being the non-SBFD symbol type, where association of the individual SPS-PDSCH message with the second symbol type is based on the individual SPS-PDSCH message being scheduled for receipt during a symbol of the non-SBFD symbol type.

In some examples, the SPS-PDSCH reception component 645 may be configured to cause the UE 115 to exclude the individual SPS-PDSCH message from monitoring based on the second symbol type being both the SBFD symbol type and the non-SBFD symbol type, where association of the individual SPS-PDSCH message with the second symbol type is based on the individual SPS-PDSCH message being scheduled for receipt during both of a symbol of the SBFD symbol type and a symbol of the non-SBFD symbol type.

In some examples, the feedback generation component 650 may be configured to cause the UE 115 to exclude the individual SPS-PDSCH message from feedback generation based on the second symbol type being both the SBFD symbol type and the non-SBFD symbol type, where association of the individual SPS-PDSCH message with the second symbol type is based on the individual SPS-PDSCH message being scheduled for receipt during both of a symbol of the SBFD symbol type and a symbol of the non-SBFD symbol type.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for more efficient utilization of communication resources, among other benefits.

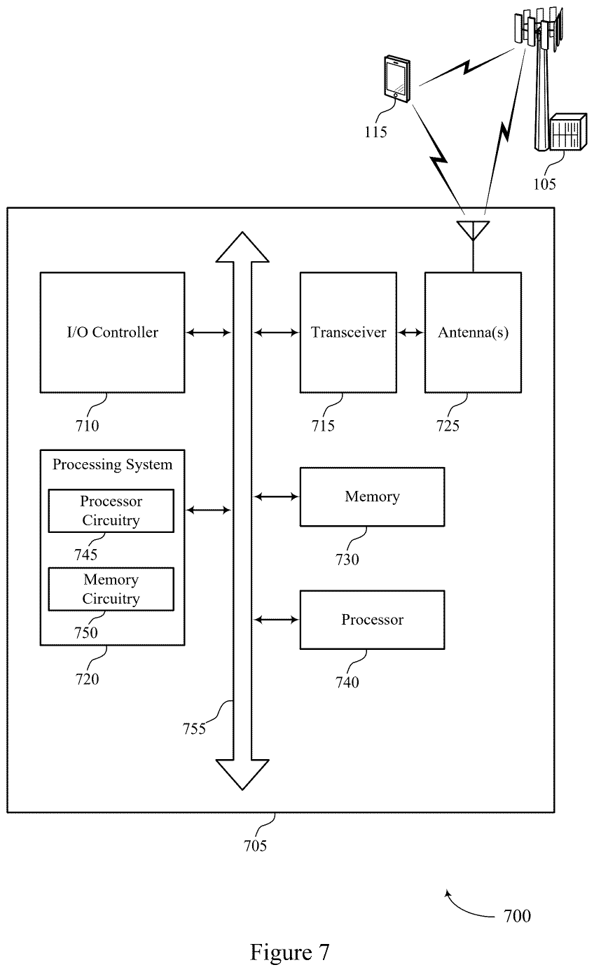

FIG. 7 shows an example of a system 700 including a device 705 that supports shared channel collision resolution and HARQ for SPS in SBFD. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support shared channel collision resolution and HARQ for SPS in SBFD. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced latency, more efficient utilization of communication resources, and improved utilization of processing capability, among other benefits.

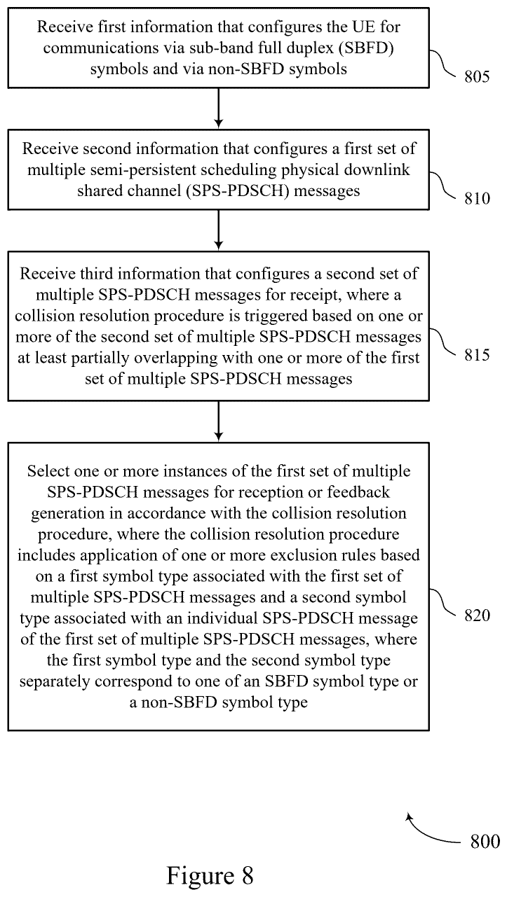

FIG. 8 shows an example of a method 800 that supports shared channel collision resolution and HARQ for SPS in SBFD. Operations of the method 800 may be performed by a UE or its components (such as using a processing system configured to cause the UE 115 to perform one or more of the operations) as described herein.

At 805, the method may include receiving first information that configures the UE for communications via SBFD symbols and via non-SBFD symbols. In some examples, aspects of the operations of 805 may be performed by a symbol type configuration component 625.

At 810, the method may include receiving second information that configures a first set of multiple SPS-PDSCH messages. In some examples, aspects of the operations of 810 may be performed by an SPS-PDSCH configuration component 630.

At 815, the method may include receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages. In some examples, aspects of the operations of 815 may be performed by a collision resolution component 635.

At 820, the method may include selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type. In some examples, aspects of the operations of 820 may be performed by an exclusion rule selection component 640.

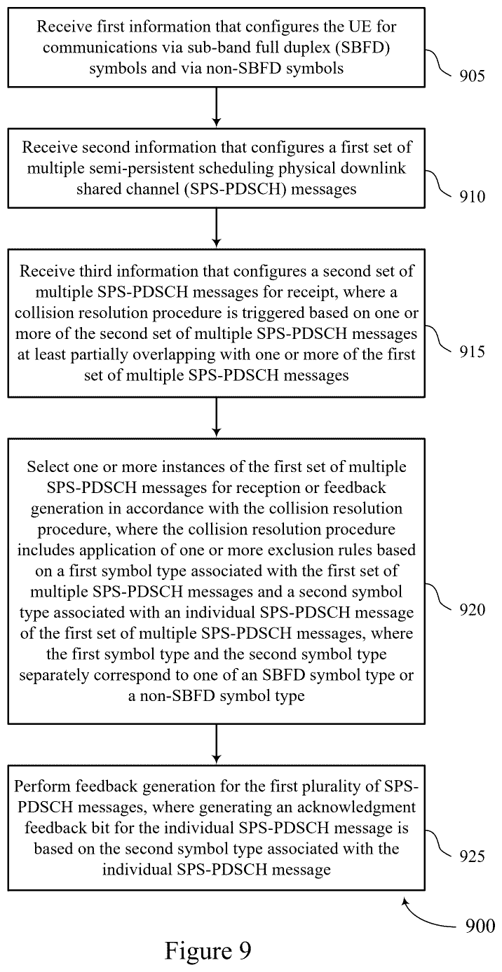

FIG. 9 shows an example of a method 900 that supports shared channel collision resolution and HARQ for SPS in SBFD. Operations of the method 900 may be performed by a UE or its components (such as using a processing system configured to cause the UE 115 to perform one or more of the operations) as described herein.

At 905, the method may include receiving first information that configures the UE for communications via SBFD symbols and via non-SBFD symbols. In some examples, aspects of the operations of 905 may be performed by a symbol type configuration component 625.

At 910, the method may include receiving second information that configures a first set of multiple SPS-PDSCH messages. In some examples, aspects of the operations of 910 may be performed by an SPS-PDSCH configuration component 630.

At 915, the method may include receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages. In some examples, aspects of the operations of 915 may be performed by a collision resolution component 635.

At 920, the method may include selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type. In some examples, aspects of the operations of 920 may be performed by an exclusion rule selection component 640.

At 925, the method may include performing feedback generation for the first plurality of SPS-PDSCH messages, where generating an acknowledgment feedback bit for the individual SPS-PDSCH message is based on the second symbol type associated with the individual SPS-PDSCH message. In some examples, aspects of the operations of 925 may be performed by a feedback generation component 650.

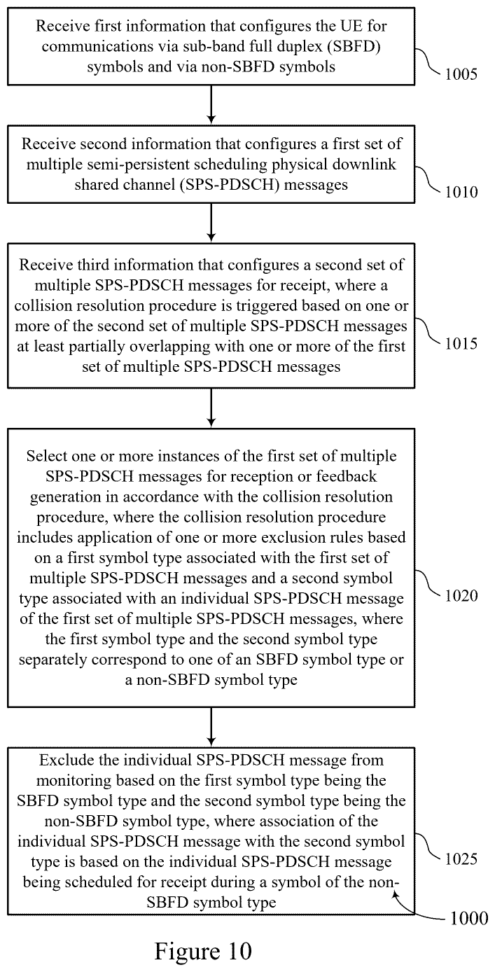

FIG. 10 shows an example of a method 1000 that supports shared channel collision resolution and HARQ for SPS in SBFD. Operations of the method 1000 may be performed by a UE or its components (such as using a processing system configured to cause the UE 115 to perform one or more of the operations) as described herein.

At 1005, the method may include receiving first information that configures the UE for communications via SBFD symbols and via non-SBFD symbols. In some examples, aspects of the operations of 1005 may be performed by a symbol type configuration component 625.

At 1010, the method may include receiving second information that configures a first set of multiple SPS-PDSCH messages. In some examples, aspects of the operations of 1010 may be performed by an SPS-PDSCH configuration component 630.

At 1015, the method may include receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages. In some examples, aspects of the operations of 1015 may be performed by a collision resolution component 635.

At 1020, the method may include selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type. In some examples, aspects of the operations of 1020 may be performed by an exclusion rule selection component 640.

At 1025, the method may include excluding the individual SPS-PDSCH message from monitoring based on the first symbol type being the SBFD symbol type and the second symbol type being the non-SBFD symbol type, where association of the individual SPS-PDSCH message with the second symbol type is based on the individual SPS-PDSCH message being scheduled for receipt during a symbol of the non-SBFD symbol type. In some examples, aspects of the operations of 1025 may be performed by an SPS-PDSCH reception component 645.

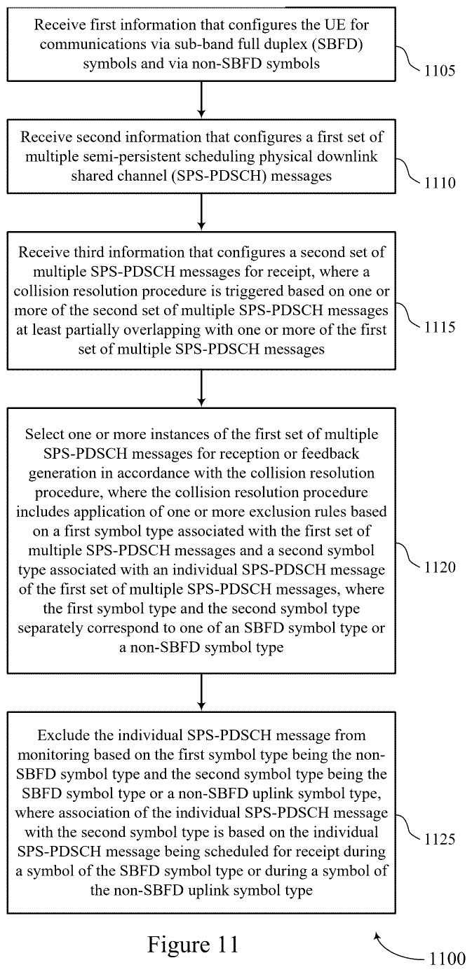

FIG. 11 shows an example of a method 1100 that supports shared channel collision resolution and HARQ for SPS in SBFD. Operations of the method 1100 may be performed by a UE or its components (such as using a processing system configured to cause the UE 115 to perform one or more of the operations) as described herein.

At 1105, the method may include receiving first information that configures the UE for communications via SBFD symbols and via non-SBFD symbols. In some examples, aspects of the operations of 1105 may be performed by a symbol type configuration component 625.

At 1110, the method may include receiving second information that configures a first set of multiple SPS-PDSCH messages. In some examples, aspects of the operations of 1110 may be performed by an SPS-PDSCH configuration component 630.

At 1115, the method may include receiving third information that configures a second set of multiple SPS-PDSCH messages for receipt, where a collision resolution procedure is triggered based on one or more of the second set of multiple SPS-PDSCH messages at least partially overlapping with one or more of the first set of multiple SPS-PDSCH messages. In some examples, aspects of the operations of 1115 may be performed by a collision resolution component 635.

At 1120, the method may include selecting one or more instances of the first set of multiple SPS-PDSCH messages for reception or feedback generation in accordance with the collision resolution procedure, where the collision resolution procedure includes application of one or more exclusion rules based on a first symbol type associated with the first set of multiple SPS-PDSCH messages and a second symbol type associated with an individual SPS-PDSCH message of the first set of multiple SPS-PDSCH messages, where the first symbol type and the second symbol type separately correspond to one of an SBFD symbol type or a non-SBFD symbol type. In some examples, aspects of the operations of 1120 may be performed by an exclusion rule selection component 640.

At 1125, the method may include excluding the individual SPS-PDSCH message from monitoring based on the first symbol type being the non-SBFD symbol type and the second symbol type being the SBFD symbol type or a non-SBFD uplink symbol type, where association of the individual SPS-PDSCH message with the second symbol type is based on the individual SPS-PDSCH message being scheduled for receipt during a symbol of the SBFD symbol type or during a symbol of the non-SBFD uplink symbol type. In some examples, aspects of the operations of 1125 may be performed by an SPS-PDSCH reception component 645.

Implementation examples are described in the following numbered clauses:

Aspect 1: A method for wireless communications at a UE, comprising: receiving first information that configures the UE for communications via SBFD symbols and via non-SBFD symbols in accordance with a first configuration for SBFD communications or a second configuration for SBFD communications, wherein the first configuration for SBFD communications defines valid symbols for the SBFD communications as corresponding to one of the SBFD symbols or the non-SBFD symbols, and wherein the second configuration for SBFD communications defines valid symbols for the SBFD communications as corresponding to both of the SBFD symbols and the non-SBFD symbols; receiving second information that configures a first plurality of SPS-PDSCH messages; receiving third information that configures a second plurality of SPS-PDSCH messages for receipt, wherein a collision resolution procedure is triggered based at least in part on one or more of the second plurality of SPS-PDSCH messages at least partially overlapping with one or more of the first plurality of SPS-PDSCH messages; and selecting one or more instances of the first plurality of SPS-PDSCH messages for reception or feedback generation in accordance with the collision resolution procedure, wherein the collision resolution procedure includes application of one or more exclusion rules based at least in part on a first symbol type associated with the first plurality of SPS-PDSCH messages and a second symbol type associated with an individual SPS-PDSCH message of the first plurality of SPS-PDSCH messages, wherein the first symbol type and the second symbol type separately correspond to one of an SBFD symbol type or a non-SBFD symbol type.

Aspect 2: The method of aspect 1, wherein the first symbol type associated with the first plurality of SPS-PDSCH messages corresponds to a type of symbol in which an initial instance of the first plurality of SPS-PDSCH messages is scheduled, and the type of symbol is one of an SBFD symbol type or a non-SBFD symbol type.

Aspect 3: The method of aspect 2, wherein the one or more exclusion rules define that the individual SPS-PDSCH message is to be excluded from monitoring in accordance with the first configuration for SBFD communications based at least in part on the second symbol type associated with the individual SPS-PDSCH message not matching the first symbol type.

Aspect 4: The method of aspect 3, further comprising: excluding the individual SPS-PDSCH message from monitoring in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

Aspect 5: The method of aspect 3, further comprising: excluding the individual SPS-PDSCH message from monitoring in accordance with the first configuration for SBFD communications based at least in part on the first symbol type being the non-SBFD symbol type and the second symbol type being the SBFD symbol type or a non-SBFD uplink symbol type, wherein association of the individual SPS-PDSCH message with the second symbol type is based on the individual SPS-PDSCH message being scheduled for receipt during a symbol of the SBFD symbol type or during a symbol of the non-SBFD uplink symbol type.

Aspect 6: The method of any of aspects 2 through 5, further comprising: performing feedback generation for the first plurality of SPS-PDSCH messages, wherein generating an acknowledgment feedback bit for the individual SPS-PDSCH message is based at least in part on the second symbol type associated with the individual SPS-PDSCH message.

Aspect 7: The method of aspect 6, wherein the one or more exclusion rules define that the individual SPS-PDSCH message is to be excluded from feedback generation in accordance with the first configuration for SBFD communications based at least in part on the second symbol type associated with the individual SPS-PDSCH message not matching the first symbol type.

Aspect 8: The method of aspect 7, further comprising: excluding the individual SPS-PDSCH message from feedback generation in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

Aspect 9: The method of aspect 7, further comprising: excluding the individual SPS-PDSCH message from feedback generation in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

Aspect 10: The method of aspect 1, further comprising: excluding the individual SPS-PDSCH message from monitoring based at least in part on the second symbol type being corresponding to both of the SBFD symbol type and the non-SBFD symbol type, wherein association of the second symbol type of the individual SPS-PDSCH message with both of the SBFD symbol type and the non-SBFD symbol type the second symbol type is based on the individual SPS-PDSCH message being scheduled for receipt during both of a symbol of the SBFD symbol type and a symbol of the non-SBFD symbol type.

Aspect 11: The method of aspect 1, further comprising: excluding the individual SPS-PDSCH message from feedback generation based at least in part on the second symbol type being corresponding to both of the SBFD symbol type and the non-SBFD symbol type, wherein association of the second symbol type of the individual SPS-PDSCH message with both of the SBFD symbol type and the non-SBFD symbol type the second symbol type is based on the individual SPS-PDSCH message being scheduled for receipt during both of a symbol of the SBFD symbol type and a symbol of the non-SBFD symbol type.

Aspect 12: The UE of any of aspects 1 through 11, wherein the first symbol type and the second symbol type correspond to one of the SBFD symbol type or the non-SBFD symbol type in accordance with the first configuration for SBFD communications.

Aspect 13: A UE for wireless communications, comprising a processing system that includes processor circuitry and memory circuitry that stores code, the processing system configured to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive first information that configures the UE for communications via sub-band full duplex (SBFD) symbols and via non-SBFD symbols in accordance with a first configuration for SBFD communications or a second configuration for SBFD communications, wherein the first configuration for SBFD communications defines valid symbols for the SBFD communications as corresponding to one of the SBFD symbols or the non-SBFD symbols, and wherein the second configuration for SBFD communications defines valid symbols for the SBFD communications as corresponding to both of the SBFD symbols and the non-SBFD symbols;
receive second information that configures a first plurality of semi-persistent scheduling physical downlink shared channel (SPS-PDSCH) messages;
receive third information that configures a second plurality of SPS-PDSCH messages for receipt, wherein a collision resolution procedure is triggered based at least in part on one or more of the second plurality of SPS-PDSCH messages at least partially overlapping with one or more of the first plurality of SPS-PDSCH messages; and
select one or more instances of the first plurality of SPS-PDSCH messages for reception or feedback generation in accordance with the collision resolution procedure, wherein the collision resolution procedure includes application of one or more exclusion rules based at least in part on a first symbol type associated with the first plurality of SPS-PDSCH messages and a second symbol type associated with an individual SPS-PDSCH message of the first plurality of SPS-PDSCH messages, wherein the first symbol type and the second symbol type separately correspond to one of an SBFD symbol type or a non-SBFD symbol type.

2. The UE of claim 1, wherein:
the first symbol type associated with the first plurality of SPS-PDSCH messages corresponds to a type of symbol in which an initial instance of the first plurality of SPS-PDSCH messages is scheduled, and
the type of symbol is one of an SBFD symbol type or a non-SBFD symbol type.

3. The UE of claim 2, wherein the one or more exclusion rules define that the individual SPS-PDSCH message is to be excluded from monitoring in accordance with the first configuration for SBFD communications based at least in part on the second symbol type associated with the individual SPS-PDSCH message not matching the first symbol type.

4. The UE of claim 3, wherein the processing system is further configured to cause the UE to:
exclude the individual SPS-PDSCH message from monitoring in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

5. The UE of claim 3, wherein the processing system is further configured to cause the UE to:
exclude the individual SPS-PDSCH message from monitoring in accordance with the first configuration for SBFD communications based at least in part on the first symbol type being the non-SBFD symbol type and the second symbol type being the SBFD symbol type or a non-SBFD uplink symbol type, wherein association of the individual SPS-PDSCH message with the second symbol type is based on the individual SPS-PDSCH message being scheduled for receipt during a symbol of the SBFD symbol type or during a symbol of the non-SBFD uplink symbol type.

6. The UE of claim 2, wherein the processing system is further configured to cause the UE to:
perform feedback generation for the first plurality of SPS-PDSCH messages, wherein generating an acknowledgment feedback bit for the individual SPS-PDSCH message is based at least in part on the second symbol type associated with the individual SPS-PDSCH message.

7. The UE of claim 6, wherein the one or more exclusion rules define that the individual SPS-PDSCH message is to be excluded from feedback generation in accordance with the first configuration for SBFD communications based at least in part on the second symbol type associated with the individual SPS-PDSCH message not matching the first symbol type.

8. The UE of claim 7, wherein the processing system is further configured to cause the UE to:
exclude the individual SPS-PDSCH message from feedback generation in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

9. The UE of claim 7, wherein the processing system is further configured to cause the UE to:
exclude the individual SPS-PDSCH message from feedback generation in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

10. The UE of claim 1, wherein the processing system is further configured to cause the UE to:
exclude the individual SPS-PDSCH message from monitoring based at least in part on the second symbol type corresponding to both of the SBFD symbol type and the non-SBFD symbol type, wherein association of the second symbol type of the individual SPS-PDSCH message with both of the SBFD symbol type and the non-SBFD symbol type is based on the individual SPS-PDSCH message being scheduled for receipt during both of a symbol of the SBFD symbol type and a symbol of the non-SBFD symbol type.

11. The UE of claim 1, wherein the processing system is further configured to cause the UE to:
exclude the individual SPS-PDSCH message from feedback generation based at least in part on the second symbol type corresponding to both of the SBFD symbol type and the non-SBFD symbol type, wherein association of the second symbol type of the individual SPS-PDSCH message with both of the SBFD symbol type and the non-SBFD symbol type is based on the individual SPS-PDSCH message being scheduled for receipt during both of a symbol of the SBFD symbol type and a symbol of the non-SBFD symbol type.

12. The UE of claim 1, wherein the first symbol type and the second symbol type correspond to one of the SBFD symbol type or the non-SBFD symbol type in accordance with the first configuration for SBFD communications.

13. A method for wireless communications at a user equipment (UE), comprising:
receiving first information that configures the UE for communications via sub-band full duplex (SBFD) symbols and via non-SBFD symbols in accordance with a first configuration for SBFD communications or a second configuration for SBFD communications, wherein the first configuration for SBFD communications defines valid symbols for the SBFD communications as corresponding to one of the SBFD symbols or the non-SBFD symbols, and wherein the second configuration for SBFD communications defines valid symbols for the SBFD communications as corresponding to both of the SBFD symbols and the non-SBFD symbols;
receiving second information that configures a first plurality of semi-persistent scheduling physical downlink shared channel (SPS-PDSCH) messages;
receiving third information that configures a second plurality of SPS-PDSCH messages for receipt, wherein a collision resolution procedure is triggered based at least in part on one or more of the second plurality of SPS-PDSCH messages at least partially overlapping with one or more of the first plurality of SPS-PDSCH messages; and
selecting one or more instances of the first plurality of SPS-PDSCH messages for reception or feedback generation in accordance with the collision resolution procedure, wherein the collision resolution procedure includes application of one or more exclusion rules based at least in part on a first symbol type associated with the first plurality of SPS-PDSCH messages and a second symbol type associated with an individual SPS-PDSCH message of the first plurality of SPS-PDSCH messages, wherein the first symbol type and the second symbol type separately correspond to one of an SBFD symbol type or a non-SBFD symbol type.

14. The method of claim 13, wherein:
the first symbol type associated with the first plurality of SPS-PDSCH messages corresponds to a type of symbol in which an initial instance of the first plurality of SPS-PDSCH messages is scheduled, and
the type of symbol is one of an SBFD symbol type or a non-SBFD symbol type.

15. The method of claim 14, wherein the one or more exclusion rules define that the individual SPS-PDSCH message is to be excluded from monitoring in accordance with the first configuration for SBFD communications based at least in part on the second symbol type associated with the individual SPS-PDSCH message not matching the first symbol type.

16. The method of claim 15, further comprising:
excluding the individual SPS-PDSCH message from monitoring in accordance with the first configuration for SBFD communications based at least in part on the first symbol type being the SBFD symbol type and the second symbol type being the non-SBFD symbol type, wherein association of the individual SPS-PDSCH message with the second symbol type is based on the individual SPS-PDSCH message being scheduled for receipt during a symbol of the non-SBFD symbol type.

17. The method of claim 15, further comprising:
excluding the individual SPS-PDSCH message from monitoring in accordance with the first configuration for SBFD communications based at least in part on the first symbol type being the non-SBFD symbol type and the second symbol type being the SBFD symbol type or a non-SBFD uplink symbol type, wherein association of the individual SPS-PDSCH message with the second symbol type is based on the individual SPS-PDSCH message being scheduled for receipt during a symbol of the SBFD symbol type or during a symbol of the non-SBFD uplink symbol type.

18. The method of claim 14, further comprising:
performing feedback generation for the first plurality of SPS-PDSCH messages, wherein generating an acknowledgment feedback bit for the individual SPS-PDSCH message is based at least in part on the second symbol type associated with the individual SPS-PDSCH message.

19. The method of claim 18, wherein the one or more exclusion rules define that the individual SPS-PDSCH message is to be excluded from feedback generation in accordance with the first configuration for SBFD communications based at least in part on the second symbol type associated with the individual SPS-PDSCH message not matching the first symbol type.

20. A non-transitory computer-readable medium storing code for wireless communications, the code comprising instructions executable by one or more processors to:
receive first information that configures a UE for communications via sub-band full duplex (SBFD) symbols and via non-SBFD symbols in accordance with a first configuration for SBFD communications or a second configuration for SBFD communications, wherein the first configuration for SBFD communications defines valid symbols for the SBFD communications as corresponding to one of the SBFD symbols or the non-SBFD symbols, and wherein the second configuration for SBFD communications defines valid symbols for the SBFD communications as corresponding to both of the SBFD symbols and the non-SBFD symbols;
receive second information that configures a first plurality of semi-persistent scheduling physical downlink shared channel (SPS-PDSCH) messages;
receive third information that configures a second plurality of SPS-PDSCH messages for receipt, wherein a collision resolution procedure is triggered based at least in part on one or more of the second plurality of SPS-PDSCH messages at least partially overlapping with one or more of the first plurality of SPS-PDSCH messages; and
select one or more instances of the first plurality of SPS-PDSCH messages for reception or feedback generation in accordance with the collision resolution procedure, wherein the collision resolution procedure includes application of one or more exclusion rules based at least in part on a first symbol type associated with the first plurality of SPS-PDSCH messages and a second symbol type associated with an individual SPS-PDSCH message of the first plurality of SPS-PDSCH messages, wherein the first symbol type and the second symbol type separately correspond to one of an SBFD symbol type or a non-SBFD symbol type.
